(19) United States
(12) Patent Application Publication
(10) Pub. No.: US 2010/0122209 A1
(43) Pub. Date: May 13, 2010

(54) Multiple Platform Optical Imager Interface and Communication System

(75) Inventor: Peter E. Mott, Baldwinsville, NY (US)

Correspondence Address: BOND, SCHOENECK & KING, PLLC, ONE LINCOLN CENTER, SYRACUSE, NY, 13202-1355, US

(73) Assignee: JADAK LLC, North Syracuse, NY (US)

(21) Appl. No.: 12/268,561

(22) Filed: Nov. 11, 2008

(51) Int. Cl. G06F 3/00; G06F 3/048

(52) U.S. Cl. 715/810; 710/5

(57) ABSTRACT

A software-based solution for managing and communicating with any number of optical imaging platforms regardless of the manufacturer or of any device specific protocols implemented by those platforms. A user interface allows selection of the function of an attached optical imaging platform that is desired by a user. The selected function is mapped to an abstracted functional layer that is then translated into the appropriate command string according to the protocol of the attached optical imaging platform. Depending on the platform that is installed, only available functions are presented in the graphical user interface. For example, a user may test the operation of the platform before installing the platform in a machine vision system, download new software to the platform to correct problems or enhance functionality after it has been installed, or obtain captured images from the platform to review the effectiveness of image processing techniques.

### BACKGROUND OF THE INVENTION

1. Field of the Invention

The present invention relates to optical imagers and, more particularly, to an interface for communicating with multiple platforms of optical imagers using a common, abstract interface.

2. Description of the Related Art

Machine vision plays an important role in automated and robotic systems, such as assembly line manufacturing, quality control inspection, and sample processing. Conventional systems are generally comprised of an optical imager, such as a charged coupled device (CCD) or similar device using digital imaging technology, that is positioned capture images of objects that pass in front of it. In low-light or enclosed applications, machine vision systems may include an illumination source, such as a bank of light emitting diodes (LEDs), positioned proximately to the imager. The images are subsequently processed to decode information contained in the resulting two-dimensional image, such as 1D linear codes, 2D stacked/matrix codes, OCR fonts, and postal codes. The image captured by the machine vision system may also be subjected to more advanced processing, such as shape recognition or detection algorithms, that provide information about the object of interest in the image.

Optical imagers are made and sold by a number of different manufacturers, each of which includes its own set of commands and capabilities governed by manufacturer specific protocols. Accordingly, integration of optical imagers into machine vision systems requires that a machine vision manufacturer and the end-user of the machine vision system have specific software and hardware dedicated to performing tasks such as performance testing, debugging, and updating of the optical imager firmware that is specifically tailored for communicating with an optical imager using its required protocol. As a result, the use of different optical imaging platforms from different manufacturers by a single entity, whether a machine vision system developer or end-user, multiplies the costs and technological investment in performing these activities as the entity must have separate software and hardware systems to communicate with each supported platform.

### BRIEF SUMMARY OF THE INVENTION

It is therefore a principal object and advantage of the present invention to provide an interface and communication system that may be used with multiple optical imaging platforms using a common, abstract interface.

It is another object and advantage of the present invention to provide an interface and communication system that simplifies manufacturing and testing procedures.

It is a further object and advantage of the present system to provide an interface and communication system that avoid the need for multiple software and hardware systems to support multiple optical imaging platforms or imager enabled devices.

It is an additional object and advantage of the present invention to provide an interface and communication system that may be customized for particular end-user needs.

It is also an object and advantage of the present invention to provide an interface and communication system that may be used for performing debugging, updating, or testing of multiple optical imaging platforms.

In accordance with the foregoing objects and advantages, the present invention comprises a programmable solution for managing and communicating with any number of optical imaging platforms regardless of the manufacturer or device specific protocols implemented by those platforms. The present invention is preferably provided as a software package residing in a host device that is interconnected to any platform optical imager via conventional interfaces and, when executed by a user, allows for meaningful communication with whichever platform optical imager is connected to the host device.

The present invention comprises a first command layer that is programmed to provide an abstracted level of functions and make those functions available to a client application, such as through a user interface. For example, a user may want to load the appropriate firmware or test the operation of the platform before installing the platform in a machine vision system, download new software to the platform to correct problems or enhance functionality after it has been installed, or obtain captured images from the platform to review the effectiveness of image processing techniques. The present invention further comprises a second command layer that is in communication with the first layer, such as by delegation or inheritance, and is capable of sending the appropriate command strings to implement functions provided by each platform according to the manufacturer-specific protocol. The commands of the second layer for each supported platform are mapped to the abstracted functions in the first module and are responsive thereto should an abstracted command of the first module be selected for execution by a user of the graphical user interface.

Once a user has selected the particular platform that is connected to the platform interface, the first command layer of the present invention instantiates the appropriate device in memory on the host system, and enables the appropriate functions that are available for use by an associated user interface for that particular platform. A user may then select or required desired function through the user interface, and the first command layer translates the selected function into the appropriate command to be sent by the second command layer according to the predetermined mapping of the functions to the available platform commands. The second command layer then sends the commands corresponding to the desired user function by sending the appropriate command data through the platform interface to the optical imaging platform using the protocol for that platform. Any data received from the optical imager in response to the command is transmitted via the platform interface to the host device and, if necessary, translated or conditioned for display to the user.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of a system for implementing a multiple platform interface and communication process according to the present invention.

FIG. 2 is a schematic of a command interface according to the present invention.

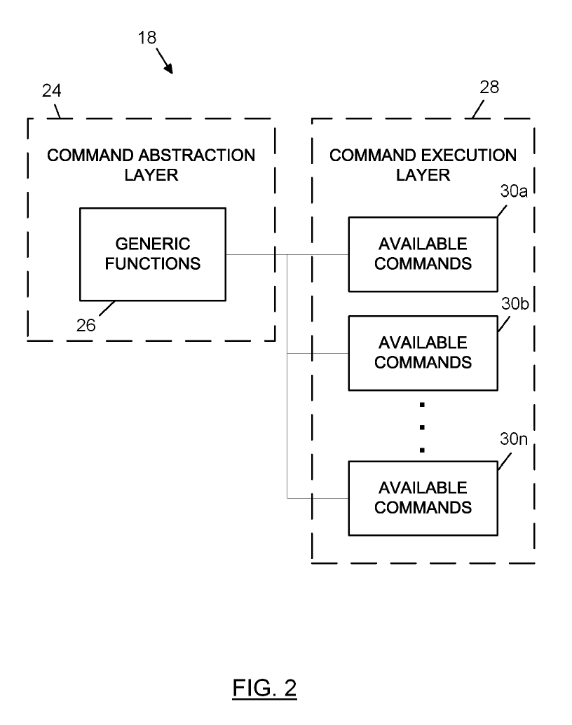

FIG. 3 is a schematic of device specific command lists according to the present invention.

FIG. 4 is a flowchart of a control process according to the present invention.

### DETAILED DESCRIPTION OF THE INVENTION

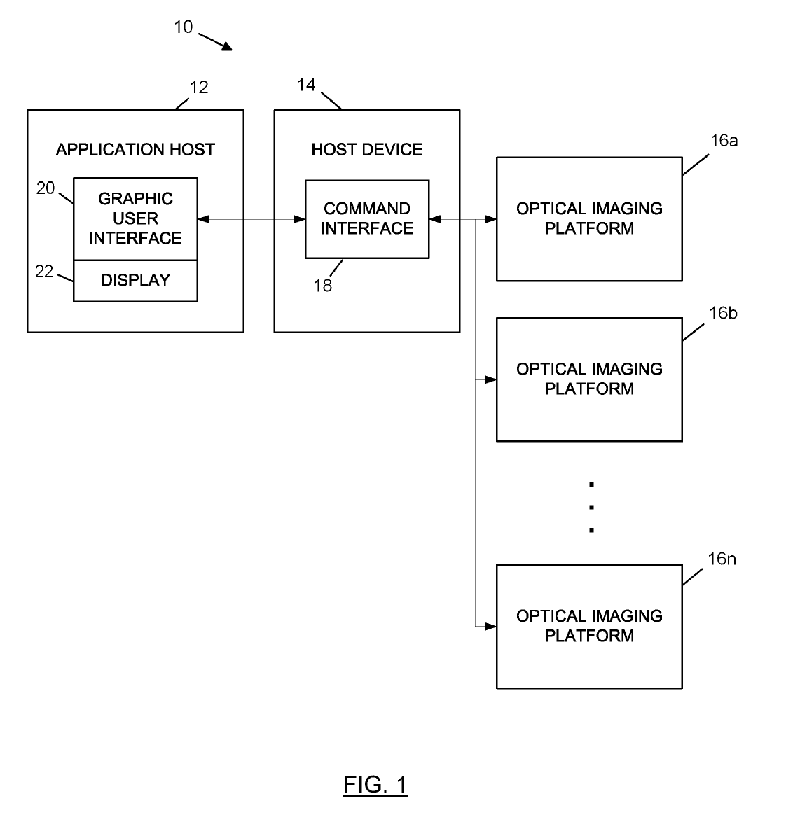

Referring now to the drawings, wherein like reference numerals refer to like parts throughout, there is seen in FIG. 1 a system 10 for implementing a multiple platform interface and communication process according to the present invention. System 10 generally comprises an application host 12, a host device 14 and at least one optical imaging platform 16 interconnected to host device 14.

For example, host device 14 may comprise a test tube rack handling system that includes an optical imaging platform 16 connected thereto to capture images and provide barcode interpretation and advanced image processing of test tubes as they pass by optical imaging platform 16. Such systems are disclosed in U.S. application Ser. Nos. 11/536,248 and 12/145,619, both of which are hereby incorporated by reference. In order to develop, program, and even test the operation of data collection, such as imaging, that is directed by host device 14, system 10 may include an application host 12 for selective connection to host device 14. Application host 12 generally comprises a PC or dedicated computer and is preferably programmed to include a graphic user interface 20 viewable on a display 22.

Host device 14 may include comprise any conventional interface for interconnecting to available optical imaging platforms 16, such as a conventional RS232 transceiver and associated 12 pin RJ style jack or other conventional buses, such as USB, IEEE 1394, 12C, SPI, or PCMCIA, or other connector styles, such as an FFC style. Host device 14 may also include a wireless transceiver for wireless communication to a host computer. Preferably, host device 14 includes an RS-232 or USB for maximum interconnectivity with existing optical imaging platforms 16, as well as application host 12.

Optical imaging platform 16 may comprise any off-the-shelf optical imager. For example, Hand Held Products, Inc. of Skaneateles Falls, N.Y. sells 5080 and 5180 series imagers that are capable of scanning and decoding most standard barcodes including linear, stacked linear, matrix, OCR, and postal codes. Other optical imaging platforms may include the EV12, EV15, EA15, and XA21 imagers available from Intermec Technologies Corporation of Everett, Wash., or any custom imaging packaging sold commercially for incorporation into machine vision or optical imaging systems. It should be recognized by those of skill in the art that the particular model or make optical imaging platforms that may be interfaced with the present invention are not important, provided that the optical imaging platforms include command capabilities through a defined protocol. It should further be recognized that the present invention may be used with other data collection devices, such as laser scanners, RFID transceivers, and the like that are host controlled and send and receive data and commands according to predefined protocols that may be adapted for communication with the common, abstract interface of the present invention.

Host device 14 of system 10 includes a command interface 18 for implementing the multiple platform interface and communication process of the present invention. Command interface 24 may be implemented on the on-board processor of host device 14, or may alternatively comprise firmware dedicated for implementing the multiple platform interface and communication process of the present invention. Command interface 18 is preferably configured to provide and communicate with graphic user interface 20. Interface 20 allows a user to interact with any attached optical imaging platform and perform various tasks, such as testing the operation of the platform, debugging software or firmware included with platform, or even updating the software or firmware of the platform. Interface 20 may also allow a user to review image processing provided by platform 14, such as the quality of barcode or image interpretation processes.

More specifically, command interface 18 comprises a command abstraction layer 24 that includes a list of functions 26 that are generic to and commonly available in conventional optical imaging platforms 16. For example, command abstraction layer 24 may include common imaging functions, such as trigger, get image, disconnect, and other control functions commonly performed by optical imaging platforms 16 in response to specific control commands.

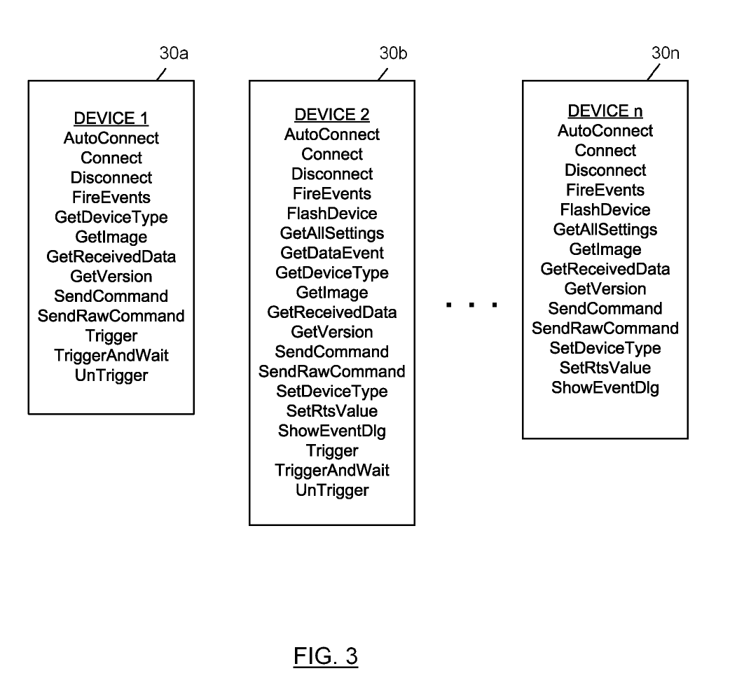

Command interface 18 further comprises a command execution layer 28 that includes a list of available commands 30 for each supported optical imaging platform that is segregated according to the particular platform. For example, as seen in FIG. 3, platform 16a may support one set of distinct commands 30a while another platform 16b supports a different set of commands 30b. The list of available commands 30 for any platform 16 may be easily populated based on the operational information provided with off-the-shelf imaging platforms 16. The commands 30 of command execution layer 28 are then mapped to the more user-friendly list of functions 26 contained in command abstraction layer 24 so that selection of a particular function from the list of functions 26 in command abstraction layer 24 will indicate a corresponding command in the command list 30 for any or all of the available platforms 16.

Command execution layer 28 is further programmed to send the appropriate command string corresponding to the commands in the command list through the platform interface 14 to an attached optical imaging platform 16. Command strings are typically ASCII or binary code strings that defined in the platform according to command protocols set by the manufacturer of the platform. As long as the appropriate command protocol is provided in command execution layer 28, system 10 may send commands to any platform regardless of the format. It should be recognized by those of skill in the art that prior to using system 10, the appropriate protocols must be configured into command execution layer 28 and mapped to the list of functions 26 in command abstraction layer 24.

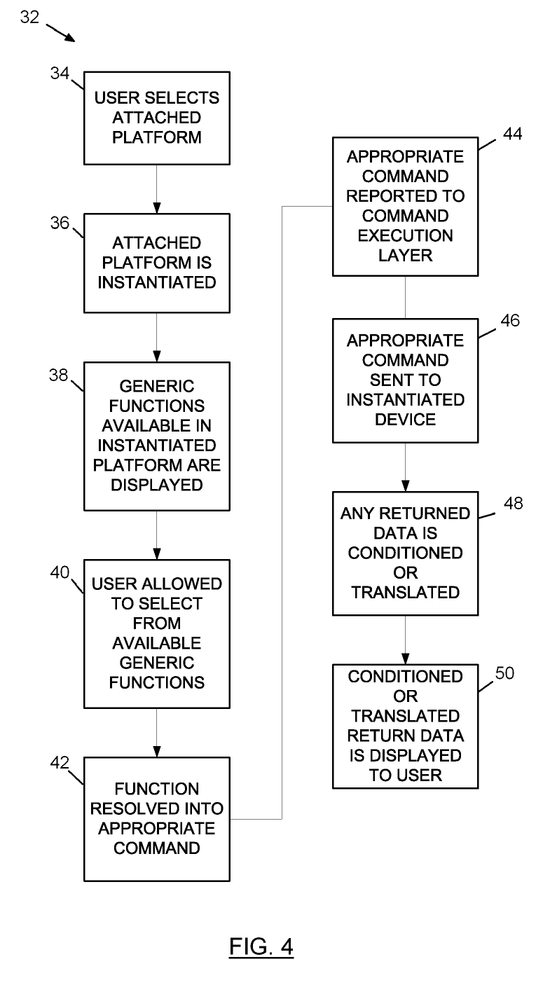

Referring to FIG. 4, the control process 32 for using multiple platform interface and communication system 10 begins by allowing a user to select 34 a specific optical imaging platform 16 that has been pre-configured into system 10 and attached to host device 12. Upon selection at step 34 of one of pre-configured platforms 14, system 10 instantiates the selected platform in memory 36, thereby enabling the available functions for that particular platform 16. The available functions from the instantiated platform 16 may then be displayed 38 for viewing and selection by a user, such as through associated graphic user interface 22.

When a user selects an available function 40 for execution in an attached optical imaging platform 14 using graphic user interface 22, the request is handled by command abstraction layer 24, which resolves the selected function into the corresponding command 42 and reports the resolved command 44 to command execution layer 26. Command execution layer 26 then executes the command 46 corresponding to the user selected function by sending the appropriate command data string or instruction to optical imaging platform 16 through interface 14. Because the specific optical imaging platform 14 was instantiated in step 36, command execution layer 26 will only execute commands corresponding to the particular optical imaging platform 14 attached to system 10. Any data returned from optical imaging platform 16 may be translated or conditioned (if necessary) 48 and reported back to the user 50 via graphical user interface 24.

Due to its ability to allow a user to communication with any optical imaging platform, system 10 provides a number of advantages over conventional platform interfaces. In the case of a manufacturer of optical imaging systems, system 10 may be used in manufacturing processes to easily test and troubleshoot products including multiple platforms. For example, without the benefit of the present invention, manufacturer must maintain a different testing station or run a separate application for each platform that must be tested. System 10 according to the present invention may be interconnected to one platform for testing and then immediately attached to a different platform for testing without the need for additional equipment or the need to run a different application on the testing equipment. The flexibility to test any product in any order provides immeasurable savings in time and expense to a machine vision system manufacturer that offers a wide variety of systems using several different optical imaging platforms. In addition, the availability of a platform independent interface alleviates the need to create platform specific application for testing and implementing new systems and devices incorporating image platforms.

System 10 may also be used by an end user of optical imaging systems to test installed equipment or perform in the field debugging and updating of software. For example, an end user having a machine vision system with more than one type of imaging platform can use a single host to perform updates on multiple platforms. Because the available functions of graphical user interface 22 are governed by the particular optical imaging platform instantiated in step 36, an end user does not need to have training or experience working with or programming various platforms, and will only be provided with options that are applicable to the platform that is attached to system 10. As a result, end user personnel do not need sophisticated training or in-depth experience working with one or more imaging platforms and may still use system 10 to perform complicated operations on platforms 14.

What is claimed is:

1. A system for managing and communicating with a plurality of data collection devices, comprising
a host device;
a platform interface interconnected to said host device;
a command interface in communication with said host device and said platform interface, wherein said command interface comprises:
a command abstraction layer including a plurality of functions, wherein each function is available in at least one of said plurality of data collection devices;
a command execution layer including a plurality of commands for use with each of said data collection devices, wherein each said plurality of commands for each of said data collection devices is mapped to a corresponding one of said plurality of functions, and wherein said command execution layer includes instructions for executing each of said commands in any of said plurality of data collection devices.

2. The system of claim 1, wherein said command execution layer is configured to execute each of said commands by sending data through said platform interface.

3. The system of claim 2, wherein said command interface is further programmed to allow a user to select which of said plurality of selected data collection device is connected to said platform interface.

4. The system of claim 3, wherein said command interface is further programmed to display only the functions available in which of said plurality of selected data collection device is selected by said user as connected to said platform interface.

5. The system of claim 4, wherein said graphical user interface displays a different screen for each of said plurality of selected data collection device depending on which of said plurality of selected data collection device is selected by said user as connected to said platform interface.

6. The system of claim 5, further comprising a graphical user interface for allowing a user to select at least one of said functions.

7. The system of claim 1, wherein said plurality of data collection devices comprise optical imaging platforms.

8. The system of claim 1, wherein said plurality of data collection devices comprise RFID transceivers.

9. The system of claim 1, wherein said plurality of data collection devices comprise laser scanners.

10. A method of managing and communicating with a plurality of data collection devices, comprising the steps of:
allowing a user to select which of said plurality of data collection devices is attached to a host device;
instantiating the selected data collection devices;
providing the user with a plurality of functions available on the selected data collection device;
allowing the user to select at least one of said plurality of functions;
resolving the selected function to determined the appropriate command for executing the function in the selected data collection device;
sending the appropriate command to an attached data collection device.

11. The method of claim 10, wherein the step of resolving the selected function to determined the appropriate command for executing the function in the selected data collection devices comprising sending data through a platform interface from said host device to said selected data collection device.

12. The method of claim 11, wherein the step of providing the user with a plurality of functions available on the selected data collection device further comprises only displaying the functions available in said selected data collection device.

13. The method of claim 12, wherein the step of providing the user with a plurality of functions available on the selected data collection devices further comprises displaying a different screen for each of said plurality of data collection devices depending on which of said plurality of data collection devices is selected by said user as connected to said platform interface.

14. The method of claim 13, wherein the step of providing the user with a plurality of functions available on the selected data collection devices further comprises providing a graphical user interface.

15. The method of claim 10, wherein said plurality of data collection devices comprise optical imaging platforms.

16. The method of claim 10, wherein said plurality of data collection devices comprise RFID transceivers.

17. The method of claim 10, wherein said plurality of data collection devices comprise laser scanners.
